(19) United States
(12) Patent Application Publication
(10) Pub. No.: US 2020/0120524 A1
(43) Pub. Date: Apr. 16, 2020

(54) Method for Controlling Block Error Rate (BLER) Testing of a Cellular Communication Device for a System Having a Fixed Number of BLER Data Packets

(71) Applicant: LitePoint Corporation, Sunnyvale, CA (US)

(72) Inventors: Christian Volf Olgaard, Saratoga, CA (US); Chen Cao, Sunnyvale, CA (US); Ruizu Wang, Santa Clara, CA (US); Yachao Ding, San Jose, CA (US)

(21) Appl. No.: 16/157,351

(22) Filed: Oct. 11, 2018

(51) Int. Cl. H04W 24/10

(52) U.S. Cl. CPC H04W 24/10

(57) ABSTRACT

A method for controlling block error rate (BLER) testing of a cellular communication device for a system having a fixed number of BLER data packets. Alternating sequences of downlink (DL) data packets have packet identifiers with first and second states, and are separated by additional sequences of DL data packets having packet identifiers with the first state, thereby enabling control of BLER testing of the device to ensure a reliable accumulated count of DL data packets received by the device having packet identifiers only with the second state.

### BACKGROUND

The present invention relates to testing wireless radio frequency (RF) communication devices, such as mobile telephone handsets, designed to communicate using data packets via cellular communication networks, and in particular, to performing such testing using only wireless RF downlink (DL) and uplink (UL) signals between the testing system and device under test (DUT).

Many of today's electronic devices use wireless signal technologies for both connectivity and communications purposes. Because wireless devices transmit and receive electromagnetic energy, and because two or more wireless devices have the potential of interfering with the operations of one another by virtue of their signal frequencies and power spectral densities, these devices and their wireless signal technologies must adhere to various wireless signal technology standard specifications.

When designing such wireless devices, engineers take extra care to ensure that such devices will meet or exceed each of their included wireless signal technology prescribed standard-based specifications. Furthermore, when these devices are later being manufactured in quantity, they are tested to ensure that manufacturing defects will not cause improper operation, including their adherence to the included wireless signal technology standard-based specifications.

Testing of such wireless devices typically involves testing of the receiving and transmitting subsystems of the device under test (DUT). The testing system will send a prescribed sequence of test data packet signals to a DUT, e.g., using different frequencies, power levels, and/or signal modulation techniques to determine if the DUT receiving subsystem is operating properly. Similarly, the DUT will send test data packet signals at a variety of frequencies, power levels, and/or modulation techniques for reception and processing by the testing system to determine if the DUT transmitting subsystem is operating properly.

For testing these devices following their manufacture and assembly, current wireless device test systems typically employ testing systems having various subsystems for providing test signals to each device under test (DUT) and analyzing signals received from each DUT. Some systems (often referred to as “testers”) include, at least, one or more sources of test signals (e.g., in the form of a vector signal generator, or “VSG”) for providing the source signals to be transmitted to the DUT, and one or more receivers (e.g., in the form of a vector signal analyzer, or “VSA”) for analyzing signals produced by the DUT. The production of test signals by the VSG and signal analysis performed by the VSA are generally programmable (e.g., through use of an internal programmable controller or an external programmable controller such as a personal computer) so as to allow each to be used for testing a variety of devices for adherence to a variety of wireless signal technology standards with differing frequency ranges, bandwidths and signal modulation characteristics.

Referring to FIG. 1, a typical testing environment 10a includes a tester 12 and a DUT 16, with test data packet signals 21t and DUT data packet signals 21d exchanged as RF signals conveyed between the tester 12 and DUT 16 via a conductive signal path 20a, typically in the form of co-axial RF cable 20c and RF signal connectors 20tc, 20dc. As noted above, the tester typically includes a signal source 14g (e.g., a VSG) and a signal analyzer 14a (e.g., a VSA). The tester 12 and DUT 16 may also include preloaded information regarding predetermined test sequences, typically embodied in firmware 14f within the tester 12 and firmware 18f within the DUT 16. The testing details within this firmware 14f, 18f about the predetermined test flows typically require some form of explicit synchronization between the tester 12 and DUT 16, typically via the data packet signals 21t, 21d. Alternatively, testing may be controlled by a controller 30 which may be integral to the tester 12 or external (e.g., a programmed personal computer) as depicted here. The controller 30 may communicate with the DUT 16 via one or more signal paths (e.g., Ethernet cabling, etc.) 31d to convey commands and data. If external to the tester 12, the controller 30 may further communicate with the tester 12 via one or more additional signal paths (e.g., Ethernet cabling, etc.) 31t to convey additional commands and data.

Referring to FIG. 2, an alternative testing environment 10b uses a wireless signal path 20b via which the test data packet signals 21t and DUT data packet signals 21d may be communicated via respective antenna systems 20ta, 20da of the tester 12 and DUT 16.

A common issue in cellular DUT testing is encountered when the DUT is queried to report the number of properly received data packets. It is often the case that some DUT drivers (e.g., resident in its internal memory as firmware) are unable to determine when data blocks have been entirely missed and thereby fail to account for them in the final tally when reporting back to the tester. This results in erroneous reported sensitivity results following an input signal power sweep when testing DUT receiver sensitivity. Particularly for cellular communication device testing, such sensitivity testing is based on block error rate (BLER) measurements.

As is well known in the art, BLER measurements are often used because they may be performed on a DUT without imposing an otherwise undesirable processing burden on the part of the DUT. An information block flow may be established by sending repeated message blocks in DL messages from a tester which may be defined at a selected layer in the protocol stack below the topmost layer. In response to such message blocks, UL messages from the DUT with embedded packets containing data acknowledging successful reception (“ACK”) or indicating unsuccessful reception (“NACK”) may be monitored by the tester to determine whether the message blocks have been correctly conveyed, and thereby derive the BLER.

Referring to FIG. 3, a comparison 40 of measured and actual BLER over time 42 by conventional techniques applied to typical DUTs can be visualized as shown. For example, the measured sensitivity 44 BLER sweep reported by the DUT driver(s) may differ substantially from the actual (or true) 46 BLER sweep. Further, as indicated by the corresponding time sweep 42, data blocks needed increases when data blocks are missed in the measurements, thereby increasing the test time required.

Ideally, if all transmitted data blocks were accounted for, one should be able to transmit a fixed number of blocks and then query the DUT driver(s) for the number of received blocks. However, in actual practice, the driver(s) do not successfully identify and/or report the initial packets received, thereby leading to a variable, but non-zero, BLER. As a result, even for traditional single point BLER testing, such testing methodology method fails. Further, the driver(s) usually require synchronization, thereby necessitating continuous data blocks transmissions.

Even if dithering techniques are used, e.g., to vary timing of respective data block transmissions, missed data packets adversely affect accuracy actual sensitivity estimates when relatively small numbers of data blocks are used. Other methods that have been tried include lowering the data packet power to make the DUT stay synchronized but missing all data blocks. However, this does not work well at lower data rates where the data channels and control channels have similar signal-to-noise ratio (SNR) requirements. Hence, traditional methods of driver-reported BLER failing to report missing data packets are of little value due to the resulting expectations of potentially significant numbers of missed data blocks.

### SUMMARY

A method for controlling block error rate (BLER) testing of a cellular communication device for a system having a fixed number of BLER data packets. Alternating sequences of downlink (DL) data packets have packet identifiers with first and second states, and are separated by additional sequences of DL data packets having packet identifiers with the first state, thereby enabling control of BLER testing of the device to ensure a reliable accumulated count of DL data packets received by the device having packet identifiers only with the second state.

In accordance with an exemplary embodiment, a method for testing a data packet signal transceiver device under test (DUT) includes:
transmitting, from a tester to a DUT, a plurality of sequences of downlink (DL) data packets, wherein each of the plurality of sequences of DL data packets includes a packet identifier with either a first state or a second state;
transmitting, from the DUT to the tester, a plurality of sequences of uplink (UL) data packets;
counting of DL data packets received by the DUT that have packet identifiers only with the second state; wherein during each of at least first and second ones of the plurality of sequences of DL data packets, each one of earlier DL data packets includes a packet identifier with the first state, each one of later DL data packets includes a packet identifier with the second state, and during a third one of the plurality of sequences of DL data packets that is temporally between the first and second ones of the plurality of sequences of DL data packets, each one of the DL data packets includes a packet identifier with the first state; and

following at least the first, second and third ones of the plurality of sequences of DL data packets, determining an accumulated count of DL data packets received by the DUT that had packet identifiers only with the second state.

### BRIEF DESCRIPTION OF THE DRAWINGS

FIG. 1 depicts a typical testing environment for a radio frequency (RF) data packet signal transceiver device under test (DUT) in a conductive, or wired, environment.

FIG. 2 depicts a typical testing environment for a RF data packet signal transceiver DUT in a radiative, or wireless, environment.

FIG. 3 depicts a comparison of measured and actual BLER test results achieved by conventional techniques applied to typical DUTs.

FIG. 4 depicts general structures for a data block and its data packets.

FIG. 5 depicts performance of BLER measurements of a data packet transceiver in accordance with conventional techniques.

FIG. 6 depicts performance of BLER measurements of a data packet transceiver in accordance with exemplary embodiments.

FIG. 7 depicts performance of BLER measurements of a data packet transceiver in accordance with further exemplary embodiments.

FIG. 8 depicts performance of BLER measurements of a data packet transceiver in accordance with further exemplary embodiments.

FIG. 9 depicts steps for performing BLER measurements of a data packet transceiver in accordance with conventional techniques.

FIG. 10 depicts steps for performing BLER measurements of a data packet transceiver in accordance with exemplary embodiments.

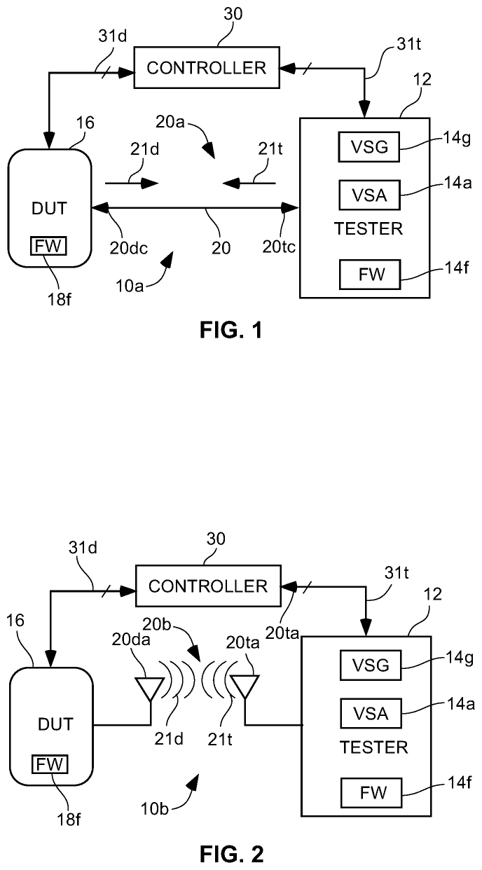

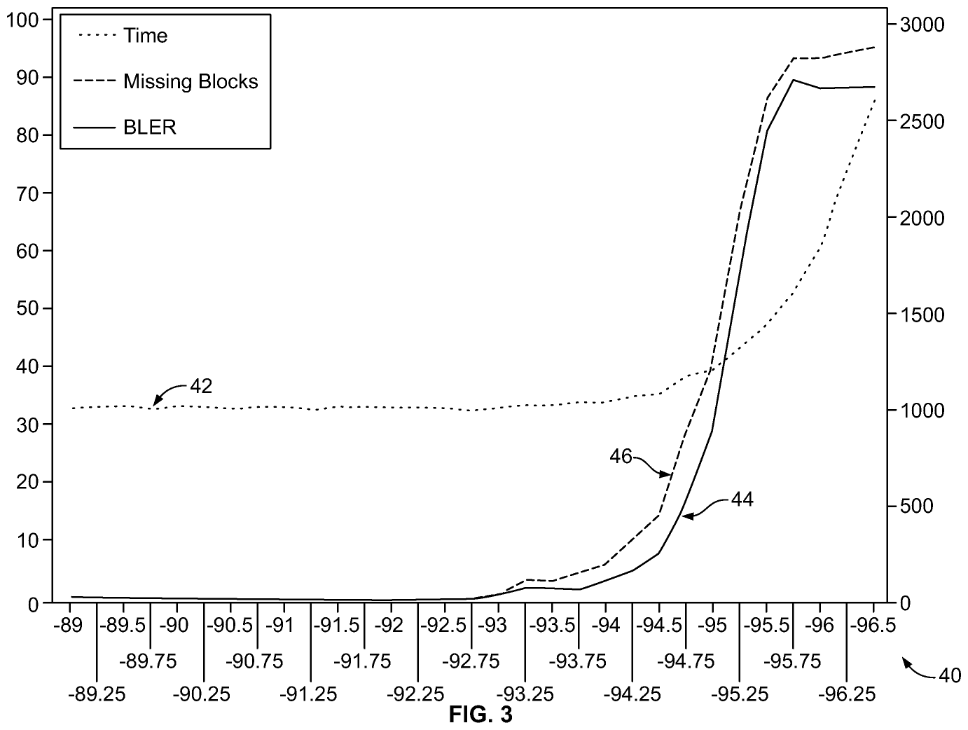

### DETAILED DESCRIPTION

The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the present invention has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed. Moreover, to the extent that the figures illustrate diagrams of the functional blocks of various embodiments, the functional blocks are not necessarily indicative of the division between hardware circuitry.

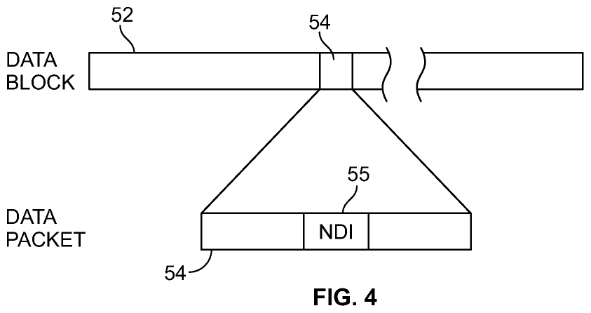

Referring to FIG. 4, in accordance with exemplary embodiments, the data blocks 52 used for testing may include data packets 54 that effectively appear as containing a “retry” command in the form of a “new data indicator” (NDI) 55 to ensure that the DUT driver does not count such data packets 54. As a result, a good first data packet will have been received after which additional data packets 54 containing the NDI (e.g., as a data bit having one of two states indicating that new data is not present) may be presented to inhibit the DUT driver from incrementing its data packet count. Subsequent data packets can later be modified as desired to reset, remove or otherwise disable the retry (NDI) bit for a desired number of data blocks before again being set or added to present more NDI-enabled data blocks to further inhibit incrementations of the data packet count. As discussed in more detail below, such NDI-enabled data blocks may be presented at various power levels, thereby selectively enabling and disabling their reception by the DUT. Additionally, such NDI-enabled data blocks may be used for traditional DUT transmit (TX) and/or received signal strength indication (RSSI) measurements, thereby avoiding need for any additional signal overhead. This may be particularly advantageous when applying a fixed number of data blocks.

As discussed in more detail below, in accordance with exemplary embodiments, NDI information in packets may be used to enable multiple useful test techniques by enabling initiation and termination of BLER testing effectively at will. For example, it may be desirable to perform a TX test and a RX BLER test (e.g., with a received signal strength indication (RSSI) test) on a set of paired RX and TX frequencies. Traditionally, after synchronization (SYNC) between the tester and DUT has been achieved, the DUT is configured and packet transmission (by the DUT) is initiated, following which the power levels of the transmitted DUT data packets are allowed to settle before capturing of the packets by the tester is attempted (for analysis in the background). This, in turn, is followed by configuring the DUT for the next TX test, again wait for transmitted DUT data packets to settle, then capture and analysis by the tester of DUT data packets, after all of which the BLER test may begin. In accordance with exemplary embodiments, NDI information may be advantageously used to pause a BLER test before it is completed to achieve significant improvement (i.e., reduction) in test time.

For example, after SYNC between the tester and DUT has been achieved and the DUT transmitter is configured, BLER testing may be initiated. Following settling of the power levels of the transmitted DUT data packets (e.g., as deemed completed based on a timer countdown associated with the VSG), packets containing appropriate NDI information may be transmitted by the tester at a higher power level (e.g., a RSSI test level) and the VSA triggered to begin capturing DUT data packets. (This may be advantageous to ensure that no RX packets are missed by the DUT as well as ensure that any changes in behavior related on the part of the DUT do not affect BLER measurements.) Following completion of a prescribed number of DUT data packets, and/or after a prescribed capture time interval has passed, the DUT may be reconfigured for another TX test interval while tester NDI packets are replaced with data packets not indicating NDI, thereby causing BLER testing to resume. During this same TX test interval, the tester may also query the RSSI measurement from the DUT, and also, if needed or otherwise desired, the tester may resume transmitting data packets with appropriate NDI information to again pause BLER testing as well as increase its transmit power during such NDI transmissions to avoid power settling issues in the DUT receiver. Then, following completion of this resumed BLER testing, the tester may again resume transmitting data packets with appropriate NDI information and increased transmit power, also perform capture and analyses of DUT data packets as well as query the BLER test results and possibly RSSI measurements.

Further, as will be readily appreciated by those skilled in the art, if more than two DUT TX sequences are needed or otherwise desired, the BLER testing may be divided into as many time intervals or segments as appropriate with little if any additional testing resources or overhead needed. As a result of this methodology, multiple subsequences of BLER test data containing corresponding subsets of the total block count may be effectively concatenated during multiple intervals of tester packet transmissions, following the completion of which the final BLER test results may be queried. A reduction in overall test time is achieved by performing BLER testing during the time intervals in which the power levels of the transmitted DUT data packets are settling and likely to be unreliable for enabling accurate DUT TX test results (e.g., RSSI).

Additionally, this methodology remains effective even when used with marginal DUTs due to the option of increasing the downlink (DL) signal power of the tester (VSG) during capture of TX data packets in the uplink (UL) signal of the DUT, as opposed to capturing TX data packets blindly during BLER testing where gaps may exist in DUT data packet transmissions as errors occur within the control channels. Accordingly, this methodology also remains effective when using dithering techniques where gaps in DUT data packet transmissions are virtually certain exist.

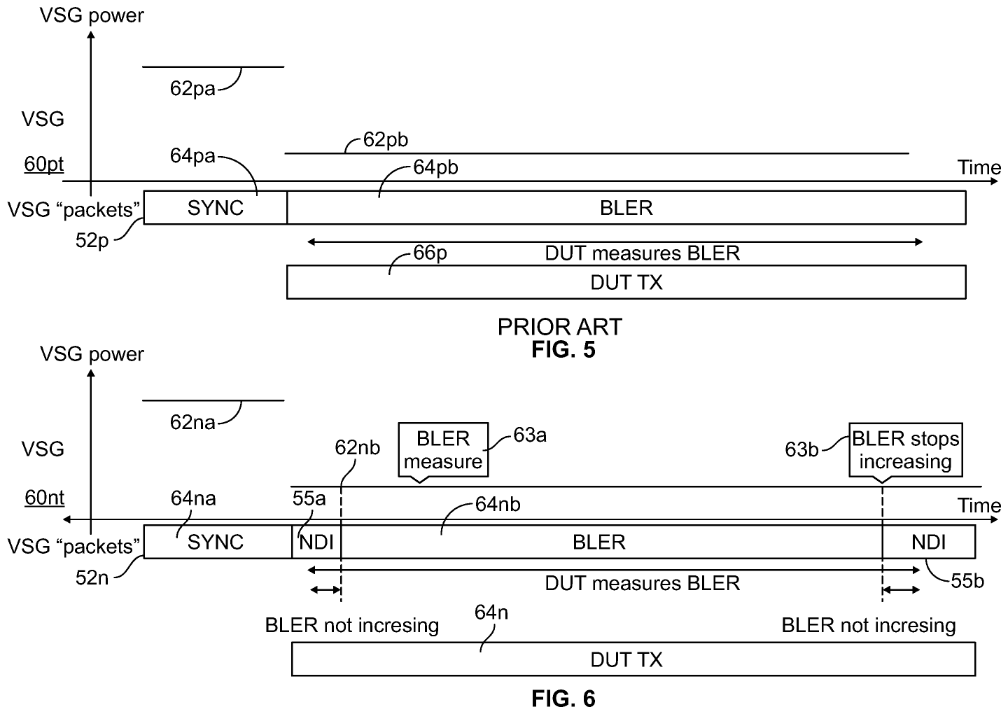

Referring to FIG. 5, in accordance with conventional techniques, operation of the tester VSG is initiated to enable BLER measurements on the part of the DUT, followed by querying the results from the DUT which responds when it has determined the BLER (not accounting for the missed packets). More particularly, testing proceeds with the tester (VSG) 60pt transmitting a sequence 52p of downlink (DL) signal blocks, including synchronization packets 64pa with the DL signal power at an elevated level 62pa. Following achievement of synchronization, the tester reduces its DL transmit power 62pb while transmitting data packets 64pb for purposes of BLER measurements by the DUT, which transmits data blocks 66p (e.g., containing ACK and/or NACK data as appropriate).

Referring to FIG. 6, in accordance with exemplary embodiments, conventional BLER testing (FIG. 5) may be improved, as part of the sequence 52n of DL signal blocks and following synchronization 64na with the DL signal power at an elevated level 62na, by transmitting data packets 55a at the reduced DL transmit power 62nb and containing NDI data indicating that no new data is being sent, thereby pausing or otherwise inhibiting BLER testing during a time interval in which it is known that BLER is not increasing. Following such time interval, transmission begins (or resumes) of data packets 64nb for purposes of BLER measurements by the DUT. Subsequently, after the predetermined number of data blocks have been transmitted thereby causing BLER to stop increasing 63b, further data packets containing NDI data 55b may be transmitted as appropriate to terminate BLER testing or initiate a new round of BLER testing.

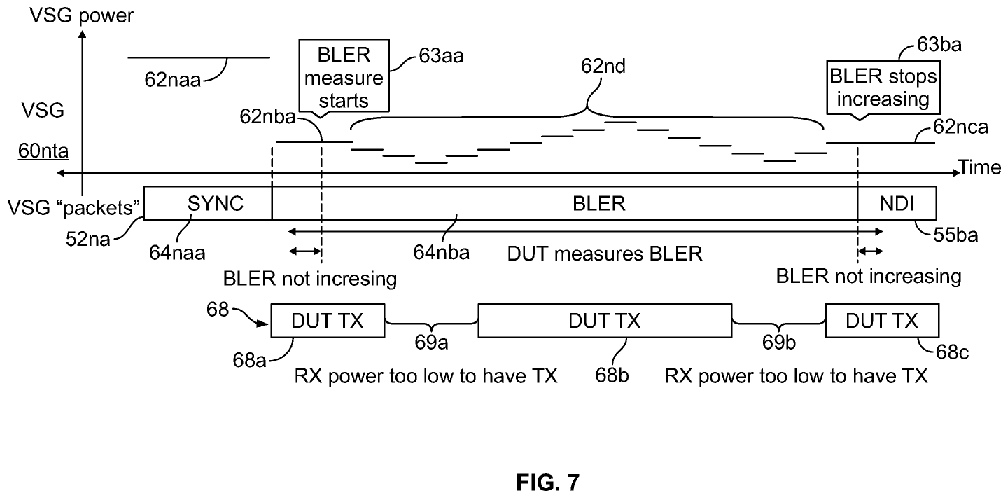

Referring to FIG. 7, in accordance with further exemplary embodiments, further improvement in BLER testing may be achieved by varying (e.g., dithering) the power level 62nd of many of the data packets 62nba transmitted for purposes of BLER measurements by the DUT. In some instances 69a, 69b, such varied power levels 62nd may be sufficiently low as to inhibit data packet transmissions 68 by the DUT.

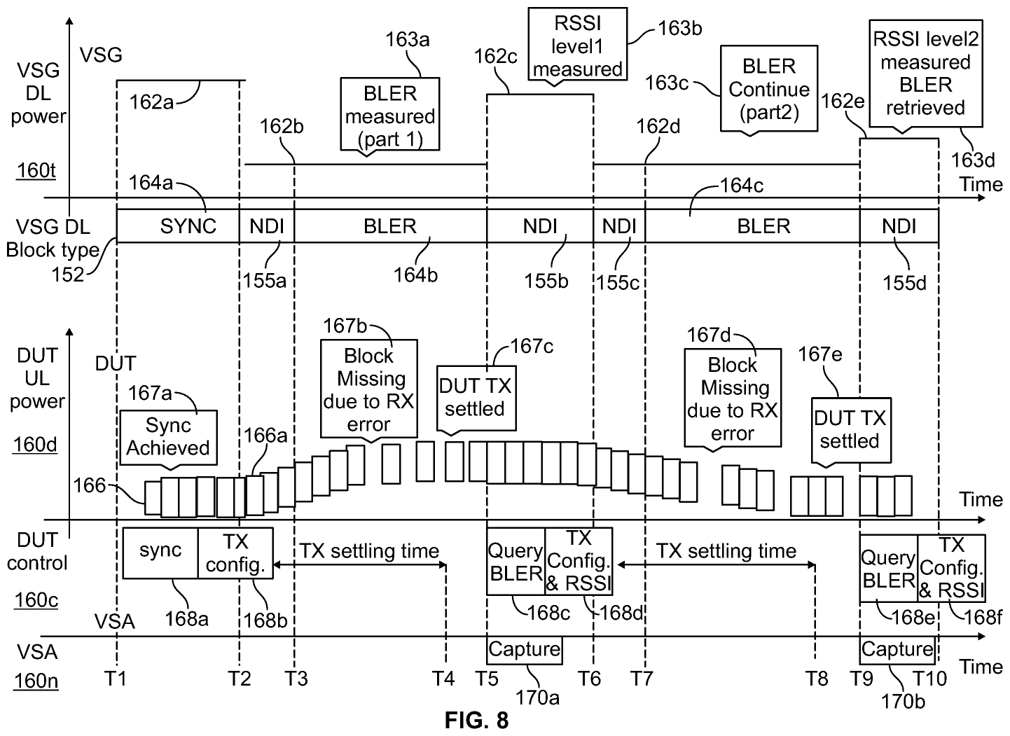

Referring to FIG. 8, in accordance with further exemplary embodiments, testing as outlined above may be described in more detail as follows in terms of actions and/or events by and/or on the part of the tester (160t, 160r) and DUT (160d, 160c). Generally, it may be desirable to establish and control the number of RX packets sent by the tester to the DUT for purposes of BLER testing as a known number. As discussed below, this may be particularly advantageous when, during such test, power levels of such packets are varied.

For example, during an overall test time interval T1-T10: tester actions and/or events 160t include a sequence 152 of various downlink (DL) signal block types 155, 164 transmitted by the VSG with various power levels 162 and measurements 163 performed; DUT transmit actions 160d include a sequence 166 of uplink (UL) signal blocks 166a transmitted by the DUT with various power levels, resulting in various events 167 (discussed in more detail below); DUT control actions 160c include various synchronizing, configuration and query actions 168; and additional tester actions and/or events 160r include captures 170 by the VSA of BLER measurement results.

During time interval T1-T2, the tester and DUT transmit their respective DL 164a and UL 168a synchronization packets, with the DL signal power at an elevated level 162a. Following achievement of synchronization 167a, the DUT initiates configuration 168b of its transmitter.

During time interval T2-T3, the tester reduces its DL transmit power 162b while transmitting data packets 155a containing NDI data indicating that no new data is being sent, thereby pausing or otherwise inhibiting BLER testing. Meanwhile, the DUT completes its transmitter configuration 168b, which causes the power level of the responsive DUT UL packets 166a to begin increasing before finally settling at their final intended power 167c during time interval T3-T4. There may also be one or more missing responsive DUT data blocks 167b to a DUT reception error during the settling time of its transmitter(s).

During time interval T3-T5, the tester transmits data blocks 164b (at the reduced DL transmit power 162b) for enabling BLER measurements 163a by the DUT.

During time interval T5-T6, the tester increases its DL transmit power 162c, to enable a RSSI measurement 163b, while again transmitting data packets 155b containing NDI data indicating that no new data is being sent, thereby pausing the previous BLER testing 164b. Meanwhile, the DUT responds to a BLER query 168c from the tester which captures 170a the results of the BLER measurements, and the DUT initiates another configuration of its transmitter and a RSSI measurement 168d.

During time interval T6-T7, the tester again reduces its DL transmit power 162d while continuing to transmit data packets 155a containing NDI data indicating that no new data is being sent, thereby continuing to pause or otherwise inhibit BLER testing. Meanwhile, the DUT completes its transmitter configuration 168d, which causes the power level of the responsive DUT UL packets 166a to begin decreasing before finally settling at their final intended power 167e during time interval T7-T8. There may also be one or more missing responsive DUT data blocks 167d to a DUT reception error during the settling time of its transmitter(s).

During time interval T7-T9, the tester resumes transmitting data blocks 164c (at the reduced DL transmit power 162c) for enabling resumption of BLER measurements 163c.

During time interval T9-T10, the tester again increases its DL transmit power 162e, e.g., to enable another RSSI measurement 163d and retrieving BLER measurements, while again transmitting data packets 155d containing NDI data indicating that no new data is being sent, thereby pausing or terminating the previous BLER testing 164c. Meanwhile, the DUT responds to another BLER query 168e from the tester which captures 170b the results of the BLER measurements, and the DUT initiates another configuration of its transmitter and another RSSI measurement 168f.

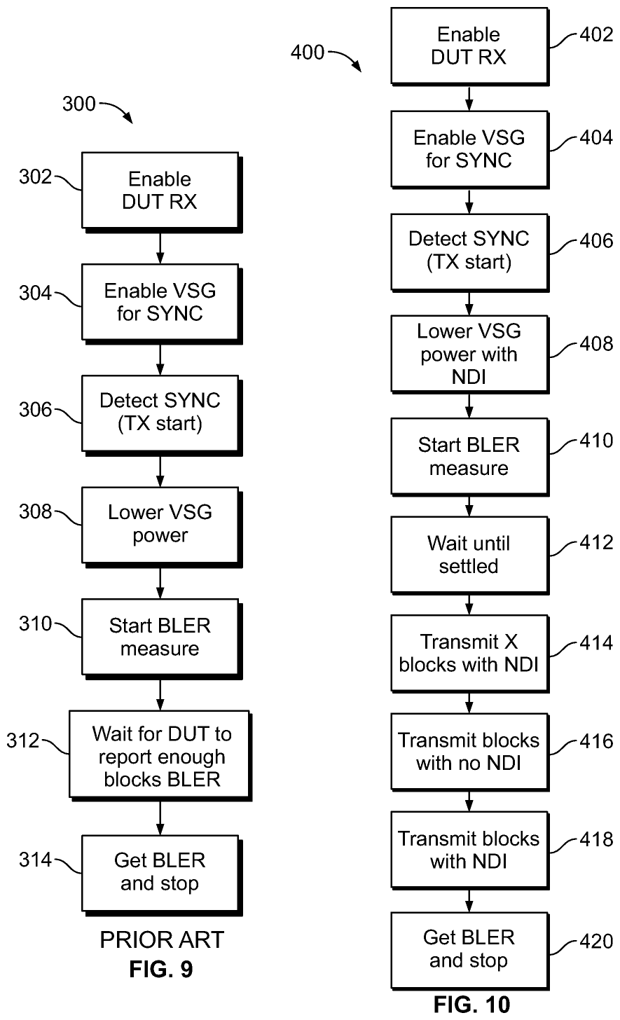

Referring to FIG. 9, BLER testing in accordance with conventional techniques (e.g., FIG. 5) 300 may begin by enabling the DUT receiver 302 and the VSG of the tester 304 for purposes of their mutual synchronization (SYNC). Following detection of the SYNC, the tester VSG begins data block transmissions 306 and reduces its signal transmission power level 308, following which the DUT begins its BLER measurements 310. Subsequently, following an indication by the DUT that sufficient data blocks have been detected and measured 312, the tester requests the measured BLER results 314 from the DUT. This process 300 may be repeated as necessary until a sufficient number of data blocks have been transmitted and/or detected to satisfy testing requirements.

Referring to FIG. 10, BLER testing in accordance with exemplary embodiments (e.g., FIG. 8) 400 may begin by enabling the DUT receiver 402 and the VSG of the tester 404 for purposes of their mutual synchronization (SYNC). Following detection of the SYNC, the tester VSG begins data block transmissions 406 and reduces its signal transmission power level 408 with NDI data indicating transmission of new data, following which the DUT begins its BLER measurements 410. Subsequently, after allowing time for the DUT TX signal characteristics (e.g., nominal signal power(s) and frequency(ies)) to settle 412, the VSG begins transmitting data blocks with new data 414. Thereafter, the VSG resumes transmitting data blocks with NDI data indicating transmission of no new data 416 to enable other testing (e.g., RSSI), followed then by transmitting data blocks with NDI data indicating transmission of new data 418 to enable resumption of BLER testing. Finally, the tester requests the measured BLER results 420 from the DUT.

As noted above and as will be readily appreciated by those skilled in the art, while this discussion has been about breaking the BLER testing into two sequences or subsets of blocks, more sequences or subsets of blocks may be used as desired depending upon other tests that may be desirable to run concurrently with or between them.

Various other modifications and alternatives in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method for testing a data packet signal transceiver device under test (DUT), comprising:
transmitting, from a tester to a DUT, a plurality of sequences of downlink (DL) data packets, wherein each of said plurality of sequences of DL data packets includes a packet identifier with either a first state or a second state;
transmitting, from said DUT to said tester, a plurality of sequences of uplink (UL) data packets;
counting of DL data packets received by said DUT that have packet identifiers only with said second state, wherein
during each of at least first and second ones of said plurality of sequences of DL data packets,
each one of earlier DL data packets includes a packet identifier with the first state,
each one of later DL data packets includes a packet identifier with the second state, and
during a third one of said plurality of sequences of DL data packets that is temporally between said first and second ones of said plurality of sequences of DL data packets, each one of said DL data packets includes a packet identifier with said first state; and
following at least said first, second and third ones of said plurality of sequences of DL data packets, determining an accumulated count of DL data packets received by said DUT that had packet identifiers only with said second state.

2. The method of claim 1, wherein said packet identifier comprises a new data indicator (NDI).

3. The method of claim 1, further comprising comparing said final accumulated count of DL data packets with a known number.

4. The method of claim 1, wherein:
during each of said first and second ones of said plurality of sequences of DL data packets, each of said DL data packets has a DL power lower than a predetermined power; and
during said third one of said plurality of sequences of DL data packets, each of said DL data packets has a DL power higher than said predetermined power.

5. The method of claim 1, wherein each of said plurality of sequences of UL data packets has a respective final power following a transition from a prior power.

6. The method of claim 5, wherein, during each of said first and second ones of said plurality of sequences of DL data packets, said earlier DL data packets include packet identifiers with said first state during at least a portion of said transition from a prior power.
